(19) United States
(12) Patent Application Publication
(10) Pub. No.: US 2022/0300231 A1
(43) Pub. Date: Sep. 22, 2022

(54) DATA TRANSMITTING METHOD OF DISPLAY DEVICE

(71) Applicant: WINSTAR DISPLAY CO., LTD., Taichung City (TW)

(72) Inventors: CHIA-HSIANG NI, Taichung City (TW); WEN-WEI CHUNG, Taichung City (TW); YU-CHANG SONG, Taichung City (TW); CHIEN-CHOU HSU, Taichung City (TW); WEN-HAO LIAO, Taichung City (TW); YU-PIN LIAO, Taichung City (TW)

(73) Assignee: WINSTAR DISPLAY CO., LTD., Taichung City (TW)

(21) Appl. No.: 17/204,696

(22) Filed: Mar. 17, 2021

(51) Int. Cl. G06F 3/14; G09G 5/14; G09G 5/393; G06F 16/17; G06F 16/16

(52) U.S. Cl. CPC G06F 3/14; G09G 5/14; G09G 5/393; G06F 16/17; G06F 16/168; G09G 2370/10; G09G 2370/16

(57) ABSTRACT

A data transmitting method of a display device, which applies to a transmitting device and the display device. The transmitting device includes a first transmitting module. The display device includes a processing module, a second transmitting module, a storage module, and a display module. The data transmission method includes steps of: select a file on the transmitting device; compress the file to form a compressed file; send the compressed file to the display device via the first transmitting module; receive the compressed file by the second transmitting module of the display device; decompress the compressed file by the processing module to obtain the file; write the file into the storage module by the processing module and correspondingly displaying on the display module based on the file. In this way, a time for transmitting the file could be effectively reduced.

### BACKGROUND OF THE INVENTION

### Technical Field

The present invention relates generally to a data transmission of an individual display device, and more particularly to a data transmitting method for transferring files from an external to a display device.

### Description of Related Art

A conventional display device is connected to a control system for displaying information of the control system to a user. Take a vehicle-mounted display device as an example, which is connected to a vehicle-mounted control system and communicates with the control system to obtain and display various information of the control system, such as vehicle speed, oil temperature, battery power, and other information. Usually, the display device communicates with the control system through a CAN-bus transmission protocol, wherein the CAN-bus transmission protocol has a good anti-noise ability, which provides a good stability of the communication. However, the disadvantage of the CAN-bus is that a transmission rate is low, wherein its maximum transmission rate is 1 Mbps, so that when an external file is to be transmitted to the display device for updating the data stored in the display device, the maximum transmission rate is limited. The user can only wait for the slow transfer of files. When the file to be sent is larger, the transmission time is longer, resulting in poor operating efficiency.

### BRIEF SUMMARY OF THE INVENTION

In view of the above, the primary objective of the present invention is to provide a data transmitting method of a display device, which could reduce a transmission time that transmits a file from an external to a display device.

The present invention provides a data transmitting method of a display device, which applies to a transmitting device and the display device. The transmitting device includes a first transmitting module. The display device includes a processing module, a second transmitting module, a storage module, and a display module, wherein the processing module is electrically connected to the second transmitting module, the storage module, and the display module. The second transmitting module is connected to the first transmitting module by signal, and a maximum transmission speed between the first transmitting module and the second transmitting module is smaller than or equal to 10 Mbps (bits per second). The data transmitting method includes steps of:

A. select a file on the transmitting device;

B. compress the file to form a compressed file;

C. send the compressed file to the display device via the first transmitting module;

D. receive the compressed file by the second transmitting module of the display device;

E. decompress the compressed file by the processing module to obtain the file;

F. write the file into the storage module by the processing module and correspondingly displaying on the display module based on the file.

With the aforementioned design, by compressing the files to be transmitted, the size of the files becomes smaller, effectively improving the efficiency of file transmission and reducing the time of transmission.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view, showing the system architecture of the transmitting device and the display device according to a first embodiment of the present invention;

FIG. 2 is a schematic view, showing the user interface displayed by the display device according to the first embodiment of the present invention;

FIG. 3 is a flowchart of the data transmitting method of the display device according to the first embodiment of the present invention;

FIG. 4 is a schematic view, showing the user interface displayed by the display device according to the first embodiment of the present invention;

FIG. 5 is a schematic view, showing the user interface displayed by the display device according to the first embodiment of the present invention;

FIG. 6 is a flowchart of the data transmitting method of the display device according to a second embodiment of the present invention;

FIG. 7 is a schematic view, showing the user interface displayed by the display device according to the second embodiment of the present invention; and

FIG. 8 is a schematic view, showing the user interface displayed by the display device according to the second embodiment of the present invention.

### DETAILED DESCRIPTION OF THE INVENTION

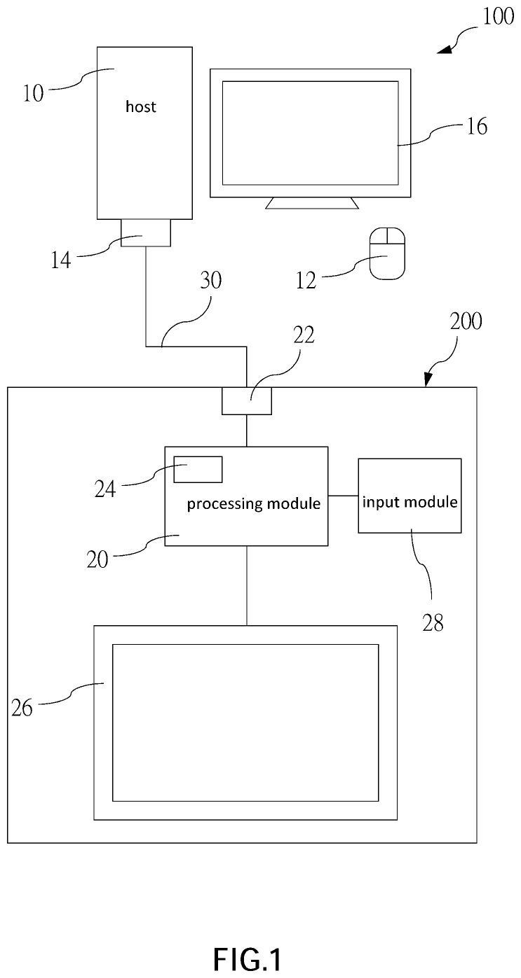

FIG. 1 is a system architecture diagram of a transmitting device 100 and a display device 200 that a data transmission method of a display device of a first embodiment of the present invention applies to.

The transmitting device 100 includes a host 10, an input module 12, a first transmitting module 14, and a monitor 16, wherein the host 10 is connected to the input module 12, the first transmitting module 14, and the monitor 16. The host 10 could be, for example, a computer host, which has a storage unit therein for storing at least one file. The input module 12 of the transmitting device 100 could be a mouse or a keyboard for operating by a user. The monitor 16 is adapted to display an information and a user interface of the host 10. The input module 12 of the transmitting device 100 could integrate with the monitor 16 as a touchscreen. In the current embodiment, the first transmitting module 14 is a wired communication module having a transmission speed below 10 Mbps (bits per second), preferably, the first transmitting module 14 is the wired communication module having the transmission speed below 1 Mbps (e.g. a CAN-bus transmitting module or a UART (Universal Asynchronous Receiver/Transmitter) transmitting module, wherein UART could be, for example, RS232, RS449, RS423, RS422, or RS485). In other embodiments, the first transmitting module 14 could be a wireless transmitting module, such as Bluetooth transmitting module, 315 MHz wireless radio frequency transmitting module, or 433 MHz wireless radio frequency transmitting module.

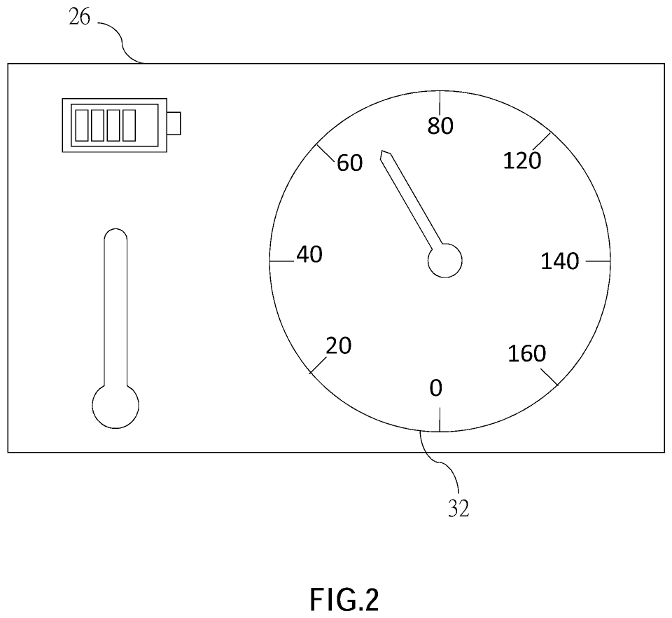

The display device 200 includes a processing module 20, a second transmitting module 22, a storage module 24, a display module 26, and an input module 28, wherein the processing module 20 could be a microcontroller and is electrically connected to the second transmitting module 22, the storage module 24, the display module 26, and the input module 28 of the display device 200. The second transmitting module 22 and the first transmitting module 14 are identical, thereby establishing communication by connecting to the first transmitting module 14 by signal. The storage module 24 is built-in the processing module 20 and has a program section and a data section, wherein the program section is adapted to store codes for the processing module to execute, and the data section is adapted to store at least one display picture file and a parameter file. The processing module 20 executes the codes and correspondingly displays a user interface (shown in FIG. 2) via the display module 26 and displays the display picture file 32. The parameter file has at least one parameter, wherein the parameter is adapted to adjust contents of the user interface. The parameter could be used to, for example, set Object Dictionary of CANopen protocol. In other embodiments, the storage module 24 could be separated from the processing module 20 and electrically connected to the processing module 20. The input module 28 of the display device 200 could be at least one button or integrate with the display module 26 to form a touchscreen. The input module 28 of the display device 200 is for a user to operate the display device 200.

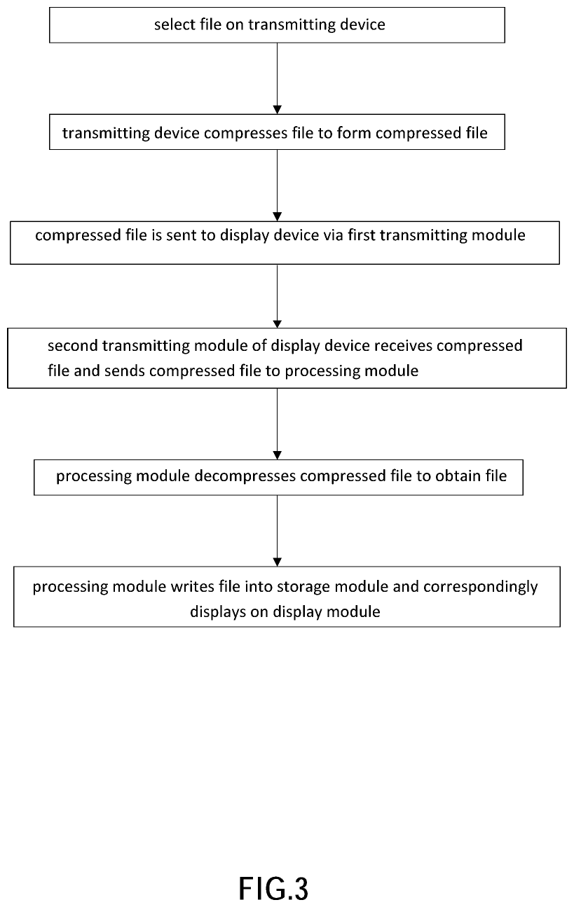

With the aforementioned design, the data transmission method of the current embodiment could be applied, wherein the data transmission method includes following steps shown in FIG. 3.

Select a file on the transmitting device 100. In the current embodiment, the user operates the host 10 via the input module 12 of the transmitting device 100 to select a file to be transmitted, wherein the file could be one of various file types such as an image file, a burning file, a text data file, etc.

The transmitting device 100 compresses the file to form a compressed file. In the current embodiment, the host 10 executes a compress program to compress the file being selected, wherein the compress program uses, but not limited to, LZMA (Lempel-Ziv-Markov chain-Algorithm) algorithm as an example to compress files. The host 10 takes a first time to compress the file to the compressed file.

The compressed file is sent to the display device 200 via the first transmitting module 14. When the first transmitting module 14 and the second transmitting module 22 are connected via a transmission line 30, the host 10 stats to transmit the compressed file through the first transmitting module 14.

The second transmitting module 22 of the display device 200 receives the compressed file and transmits the compressed file to the processing module 20.

After the processing module 20 receives the compressed file, the compressed file is decompressed by the processing module 20 to obtain the file. In the current embodiment, the processing module 20 uses LZMA algorithm for decompression to obtain the file, wherein the processing module 20 takes a second time to decompress the compressed file, and the second time is smaller than or equal to the first time that the host 10 takes for compression.

After that, the processing module 20 writes the file into the storage module 24 and correspondingly displays on the display module 26. In the current embodiment, the processing module 20 determines file types of the file being obtained and correspondingly reacts depending on different file types. For example, a file extension name of the file could be used to determine the file type of the file.

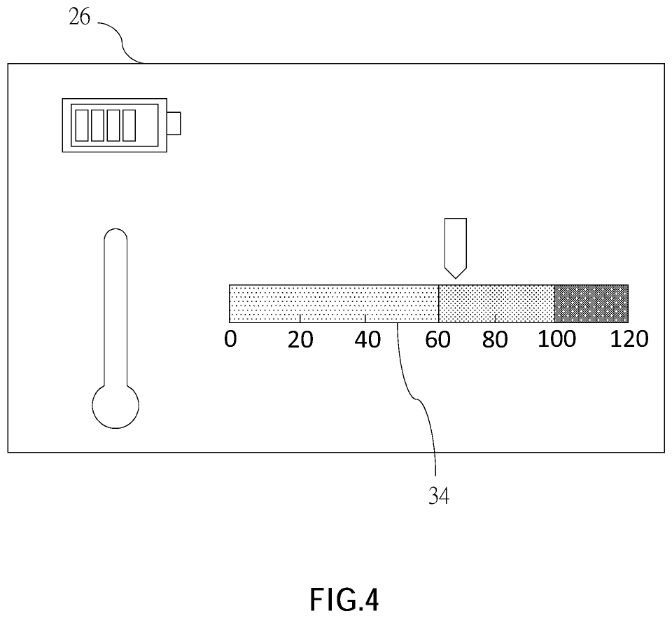

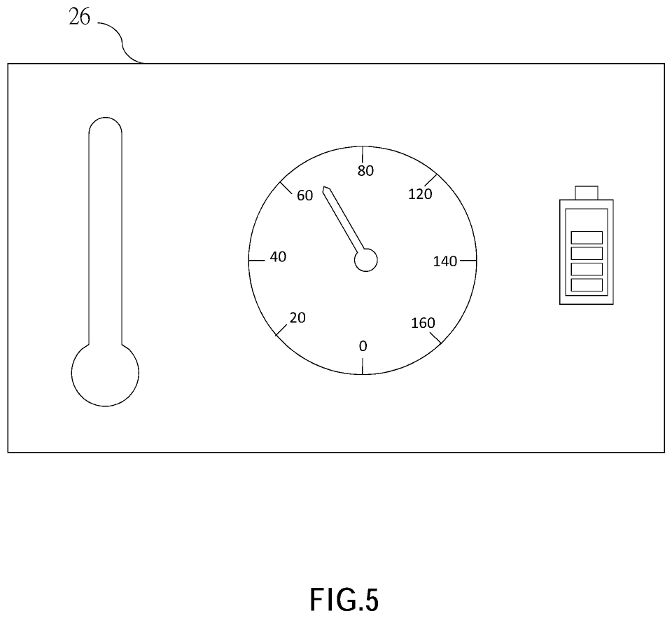

For instance, when the file is determined as a picture file, the processing module 20 writes the picture file into the data section of the storage module 24 and updates the display picture file, and displays a prompt of successful transmission and/or the updated display picture file 34 (shown in FIG. 4) on the display module 26. When the file is determined as a burning file, the processing module 20 writes the burning file into the program section of the storage module 24 to form a new code, and displays a prompt of successful programming on the display module 26, and then the processing module 20 executes the new code to display an operation script or a user interface (shown in FIG. 5) that is different from the original code generates. In the current embodiment, different operating screens are displayed based on different operation scripts. When the file is determined as a text data file, the processing module 20 writes the text data file into the data section of the storage module 24 to form at least one parameter of a new parameter file, and displays a prompt of successful transmission on the display module 26, and adjusts contents of the user interface on the display module 26 based on the parameter of the storage module 24.

Then, the user could interrupt the signal connection between the first transmitting module 14 and the second transmitting module 22, for example, the user could detach the transmission line 30 from the first transmitting module 14 or the second transmitting module 22, so that the display device 200 could operate independently and display the corresponding screen on the display module 26. In addition, the user could also perform corresponding operations through the input module 28 of the display device 200.

With the aforementioned data transmission method, although the transmission speeds of the first transmitting module 14 and the second transmitting module 22 are lower than 10 Mbps, the CAN-bus could provide a good transmission stability and the time for transmitting the compressed file could be effectively reduced due to a size of the file becomes smaller by compressing the file to be transmitted to the display device 200 to the compressed file. The processing module 20 of the display device 200 decompresses the compressed file to the original file to store the file and/or update data in the storage module 24. In other embodiments, the file could be a video file, a sound file, etc., wherein the processing module 20 plays the acquired video file on the display module 26, and the sound file plays sound through a speaker electrically connected to the processing module 20.

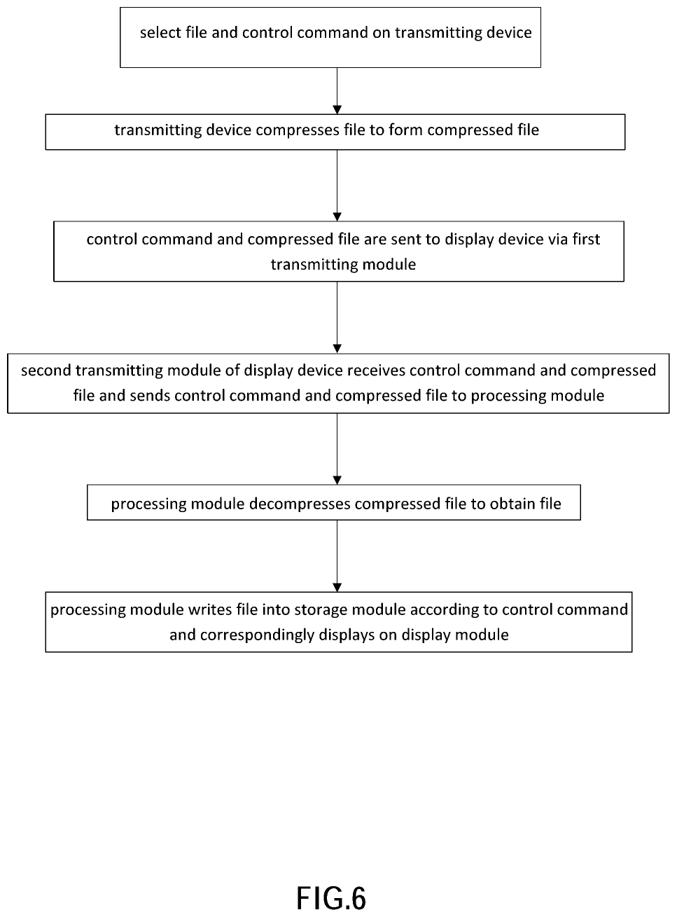

A data transmission method of a display device according to a second embodiment of the present invention is illustrated in FIG. 6, which also applies to the system architecture of the first embodiment, wherein the data transmission method of the current embodiment has almost the same steps as that of the first embodiment. The data transmission method of the current embodiment includes following steps.

Select a file and select a control command on the transmitting device 100. In the current embodiment, the file could be a picture file, a burning file, a text data file, etc. The control command selects one of a plurality of control commands, wherein the control commands include an update picture command, a burning command, and a parameter update command and respectively correspond to different file types.

The transmitting device 100 compresses the file to a compressed file.

The control command being selected and the compressed file being selected are sent to the display device 200 via the first transmitting module 14. In the current embodiment, the host 10 encapsulates the control command being selected and the compressed file being selected into at least one packet and then sends the at least one packet through the first transmitting module 14, wherein the control command is recorded in a header field of the packet.

The second transmitting module 22 of the display device 200 receives the control command and the compressed file and transmits the control command and the compressed file to the processing module 20. In the current embodiment, the second transmitting module 22 receives the packet and transmits the packet to the processing module 20, and the processing module 20 analyzes the packet to obtain the control command and the compressed file.

After the processing module 20 receives the compressed file, the processing module 20 decompresses the compressed file to obtain the file.

After that, the processing module 20 writes the file into the storage module 24 based on the control command and correspondingly displays on the display module 26 based on the file. In the current embodiment, the processing module writes the file into different sections of the storage module 24 depending on different control commands.

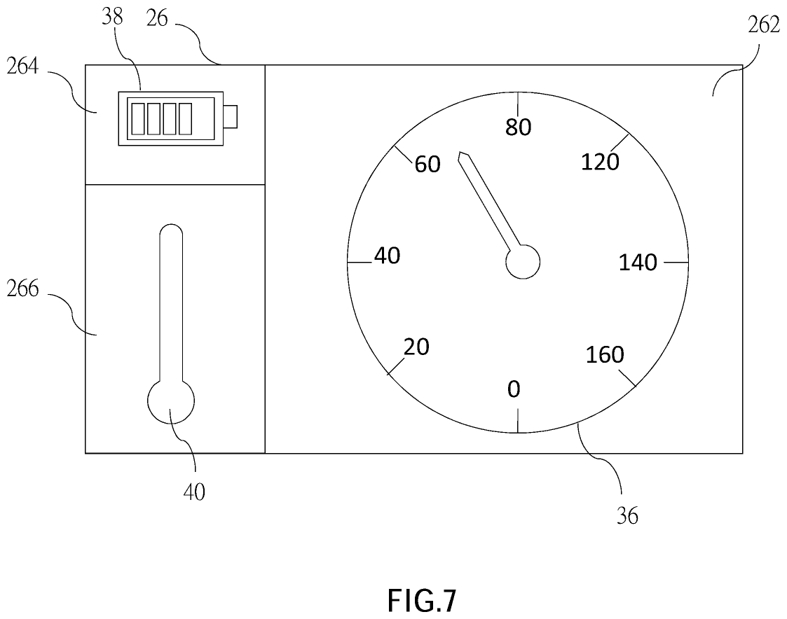

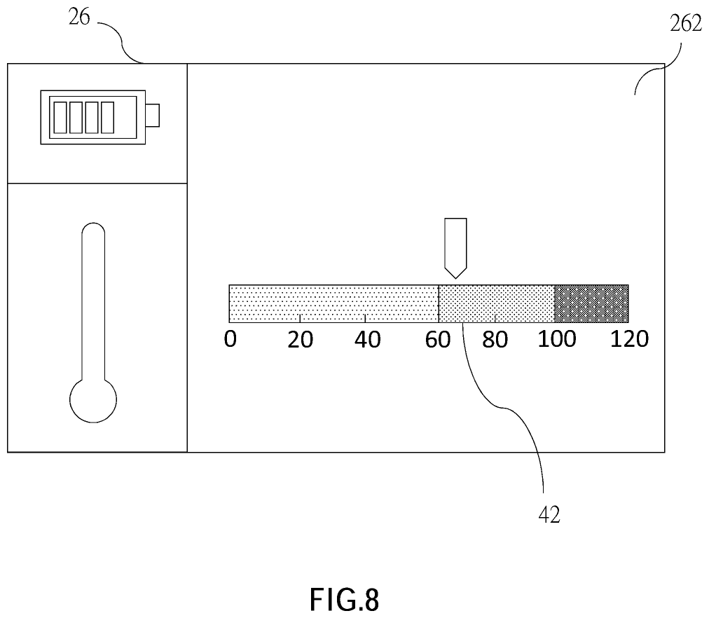

When the processing module 20 determines that the control command is the update picture command, which means that the file being sent is the picture file, the processing module 20 writes the picture file into the data section of the storage module 24 based on the update picture command, and updates the at least one original display picture file, and displays the update display picture file on the display module 26. Referring to FIG. 7, the display module 26 has a plurality of displaying areas 262, 264, 266, and a plurality of display picture files 36, 38, 40 is stored in the data section of the storage module 24, wherein the processing module 20 respectively displays the display picture files 36, 38, 40 on the displaying areas 262, 264, 266. The update picture command includes a target area corresponding to one of the displaying areas 262, 264, 266. In other words, the target area is adapted to specify at least one of the display areas 262 to be updated and at least one of the display picture files 36 corresponding to the display areas 262. The processing module 20 writes the picture file into the data section of the storage module 24 based on the target area of the update picture command, and updates the display picture file 36 of the displaying areas 262 corresponding to the target area, and displays a prompt of successful programming on the display module 26 and/or displays the updated display picture file 42 (shown in FIG. 8) on the corresponding displaying area 262.

When the processing module 20 determines that the control command is the burning command, which means that the file being sent is the burning file, the processing module 20 writes the burning file into the program section of the storage module 24 based on the burning command to form a new code, and displays a prompt of successful programming on the display module 26, and then the processing module 20 executes the new code to display an operation script or a user interface that is different from the original code generates.

When the processing module 20 determines that the control command is the parameter update command, which means that the file being sent is the text data file, the processing module 20 writes the text data file into the data section of the storage module 24 to form at least one parameter of a new parameter file, and displays a prompt of successful transmission on the display module 26, and adjusts contents of the user interface on the display module 26 based on the parameter of the storage module 24.

In the current embodiment, by selecting the control command, the processing module 20 of the display device 200 could store the file and/or update data in the storage module 24 based on the control command, which could have the transmission stability of CAN-bus and also effectively improve an efficiency of file transmission and reduce a time of file transmission by compressing the file.

It must be pointed out that the embodiments described above are only some preferred embodiments of the present invention. All equivalent methods which employ the concepts disclosed in this specification and the appended claims should fall within the scope of the present invention.

What is claimed is:

1. A data transmitting method of a display device, which applies to a transmitting device and the display device, wherein the transmitting device comprises a first transmitting module; the display device comprises a processing module, a second transmitting module, a storage module, and a display module; the processing module is electrically connected to the second transmitting module, the storage module, and the display module, wherein the second transmitting module is connected to the first transmitting module by signal, and a maximum transmission speed between the first transmitting module and the second transmitting module is smaller than or equal to 10 Mbps (bits per second); the data transmitting method comprising steps of:
A. selecting a file on the transmitting device;
B. compressing the file to form a compressed file;
C. sending the compressed file to the display device via the first transmitting module;
D. receiving the compressed file by the second transmitting module of the display device;
E. decompressing the compressed file by the processing module to obtain the file; and
F. writing the file into the storage module by the processing module and correspondingly displaying on the display module based on the file.

2. The method as claimed in claim 1, wherein in step A, further comprising a step of selecting a control command on the transmitting device; in step C, further comprising a step of sending the control command to the display device through the first transmitting module; in step D, further comprising a step of receiving the control command by the second transmitting module; in step F, the file is written into the storage module based on the control command.

3. The method as claimed in claim 2, wherein at least one display picture file is stored in the storage module; in step A, the file is a picture file, and the control command is an update picture command; in step F, the processing module writes the picture file into the storage module based on the update picture command, and updates the at least one display picture file, and displays the at least one display picture file, which is updated, on the display module.

4. The method as claimed in claim 3, wherein the display module has a plurality of displaying areas; the at least one display picture file comprises a plurality of display picture files stored in the storage module; the display picture files are respectively displayed on the displaying areas; the update picture command comprises a target area corresponding to one of the displaying areas; in step F, the processing module writes the picture file into the storage module based on the update picture command, and updates one of the display picture files of one of the displaying areas corresponding to the target area, and correspondingly displays one of the display picture files, which is updated, on one of the displaying areas corresponding to the target area on the display module.

5. The method as claimed in claim 2, wherein the storage module has a program section; in step A, the file is a burning file, and the control command is a burning command; in step F, the processing module writes the burning file into the program section of the storage module based on the burning command to form a code, and then the processing module runs the code.

6. The method as claimed in claim 2, wherein in step A, the file is a text data file, and the control command is a parameter update command; in step F, the processing module writes the text data file into the storage module based on the parameter update command to form at least one parameter, and then the processing module reads the at least one parameter of the storage module.

7. The method as claimed in claim 2, wherein in step A, the transmitting device has a plurality control commands comprising an update picture command and a burning command, and one of the control commands is selected in step A; when one of the control commands, which is selected, is the update picture command, the processing module writes the file into the storage module and updates at least one display picture file with the file based on the update picture command in step F; when one of the control commands, which is selected, is the burning command, the processing module writes the file into a program section of the storage module based on the burning command to form a code in step F, and then the processing module runs the code.

8. The method as claimed in claim 2, wherein in step C, both of the control command and the compressed file are encapsulated into at least one packet, and the at least one packet is sent via the first transmitting module; in step D, the second transmitting module receives the at least one packet and transmits the at least one packet to the processing module to obtain the control command and the compressed file.

9. The method as claimed in claim 1, wherein in step B, it takes a first time to compress the file to the compressed file, in step E, the processing module takes a second time to decompress the compressed file; the second time is smaller than or equal to the first time.

10. The method as claimed in claim 1, wherein the first transmitting module is connected to the second transmitting module in a wired way; the maximum transmission speed between the first transmitting module and the second transmitting module is smaller than or equal to 1 Mbps (bits per second).

11. The method as claimed in claim 10, wherein the first transmitting module is either a CAN-bus transmitting module or a UART (Universal Asynchronous Receiver/Transmitter) transmitting module, and the second transmitting module and the first transmitting module are identical.

12. The method as claimed in claim 1, wherein the first transmitting module is connected to the second transmitting module in a wireless way.
